(19) United States
(12) Patent Application Publication
(10) Pub. No.: US 2007/0290571 A1
(43) Pub. Date: Dec. 20, 2007

(54) Spindle Motor

(76) Inventor: HO EOP YOON, Suwon-si (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/763,958

(22) Filed: Jun. 15, 2007

(30) Foreign Application Priority Data
Jun. 16, 2006 (KR) 10-2006-0054346

(51) Int. Cl. H02K 7/00; H02K 5/16; G11B 17/02

(52) U.S. Cl. 310/261; 310/67 R; 310/90; 360/99.08

(57) ABSTRACT

A spindle motor can include a base; a bearing housing supported on the base and having a bearing therein; a rotating shaft rotatably supported by the bearing; a stator installed around the bearing housing and having a core and a coil; and a rotor coupled with the rotating shaft and including a rotor yoke supported on a top surface of the rotating shaft and a magnet supported by the rotor yoke.

### CROSS-REFERENCE TO RELATED APPLICATION

The present application claims the benefit under 35 U.S.C. §119 of Korean Patent Application No. 10-2006-0054346, filed Jun. 16, 2006, which is hereby incorporated by reference in its entirety.

### BACKGROUND

In general, a spindle motor is installed in an ODD (optical disk drive) in order to rotate a disk such that an optical pickup, which linearly reciprocates in the ODD, can read out data recorded on the disk.

### BRIEF SUMMARY

This disclosure provides embodiments of a spindle motor.

An embodiment provides a spindle motor that can include: a base; a bearing housing supported on the base and having a bearing therein; a rotating shaft rotatably supported by the bearing; a stator installed around the bearing housing and having a core and a coil; and a rotor coupled with the rotating shaft and including a rotor yoke supported on a top surface of the rotating shaft and a magnet supported by the rotor yoke.

An embodiment provides spindle motor that can include: a base having a bearing housing; a bearing installed in the bearing housing; a rotating shaft rotatably supported in the bearing and including a lower portion having a first diameter and an upper portion having a second diameter smaller than the first diameter; a stator installed around the bearing housing and having a core and a coil; and a rotor including a rotor yoke supported by making contact with a top surface of the lower portion of the rotating shaft and a lateral surface of the upper portion of the rotating shaft, and a magnet supported by the rotor yoke.

### BRIEF DESCRIPTION OF THE DRAWINGS

FIG. 1 is a sectional view showing the structure of a spindle motor according to an embodiment;

FIG. 2 is an enlarged view of “A” shown in FIG. 1;

FIG. 3 is a sectional view showing the structure of a spindle motor according to an embodiment;

FIG. 4 is an enlarged view of “B” shown in FIG. 3;

FIG. 5 is a sectional view showing the structure of a spindle motor according to an embodiment; and

FIG. 6 is an enlarged view of “C” shown in FIG. 5.

### DETAILED DESCRIPTION

Hereinafter, embodiments of a spindle motor will be described with reference to accompanying drawings.

### First Embodiment

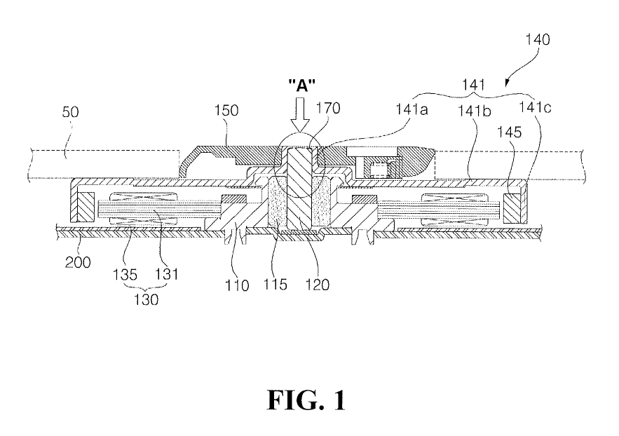

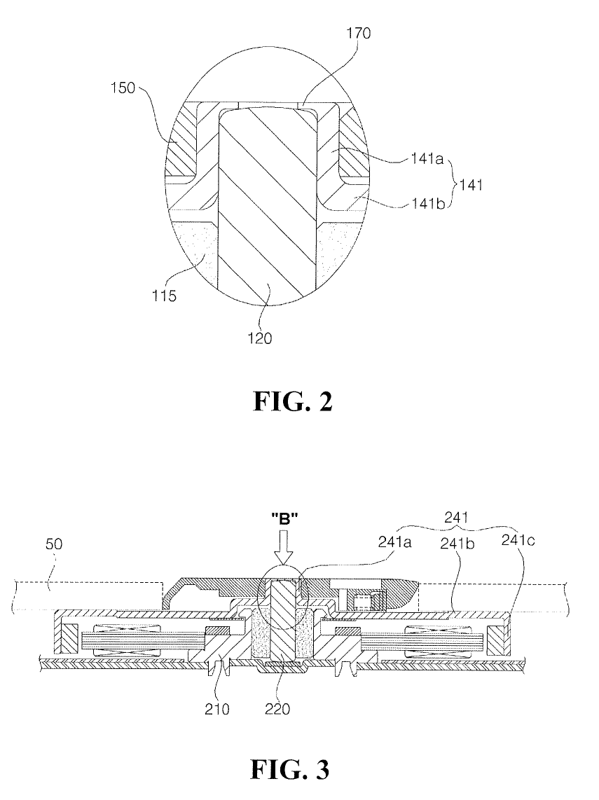

FIG. 1 is a sectional view showing the structure of a spindle motor according to an embodiment, and FIG. 2 is an enlarged view of “A” shown in FIG. 1.

Referring to FIGS. 1 and 2, a spindle motor can include a bearing housing 110, which has a cylindrical structure with an opened upper surface, installed on a base 200.

A bearing 115 can be press-fitted into the bearing housing 110, and a lower portion of a rotating shaft 120 can be rotatably inserted into the bearing 115. A portion of the rotating shaft 120 can protrude upward from the bearing housing 110.

A stator 130 can be fixedly coupled with an outer peripheral surface of the bearing housing 110, and a rotor 140 can be fixedly coupled with an outer peripheral surface of the rotating shaft 120.

The stator 130 can include a core 131 fixed to an outer peripheral surface of the bearing housing 110, and a coil 135 wound around the core 131.

The rotor 140 can include a cylindrical rotor yoke 141 and a magnet 145. The rotor yoke 141 can be fixedly fitted and bonded around the outer peripheral surface of the rotating shaft 120 and a disk 50 can be mounted thereon. The magnet 145 can be fixed to an inner peripheral surface of the rotor yoke 141 while facing the stator 130.

In operation, as current is applied to the coil 135, the rotor 140 rotates due to interaction between an electric field generated from the coil 135 and a magnetic field generated from the magnet 145, so that the rotating shaft 120 coupled with the rotor 140 also rotates.

A clamp 150 can be installed on the rotor yoke 141. The clamp 150 can be used to elastically support the disk 50 in such a manner that the center of the disk 50 mounted on the rotor yoke 141 matches with the center of the rotating shaft 120.

The rotor yoke 141 can be fixedly fitted around the rotating shaft 120 and bonded thereto.

When assembling or using the spindle motor, if excessive load is applied to the rotor yoke 141 from the top thereof, the rotor yoke 141 may be separated from the rotating shaft 120 and moved toward the base 200.

In this case, the rotor yoke 141 may collide with other components and the magnet 145 and the stator 130 may deviate from the predetermined position, so that the spindle motor may malfunction.

In an embodiment to address this problem, a spindle motor can include a device for inhibiting the rotor yoke 141 from moving toward the lower end portion of the rotating shaft 120.

In one embodiment as illustrated in FIGS. 1 and 2, the rotor yoke 141 can include a coupling section 141a, which is fitted and bonded around the outer peripheral surface of the rotating shaft 120 protruding upward from the bearing housing 110, a ring-shaped table 141b extending outward from a lower outer peripheral surface of the coupling section 141a to support the disk 50 mounted thereon, and an outer wall 141c extending downward from the outer peripheral surface of the table 141b to surround the stator 130. The table 141b may have a stepped structure corresponding to an external shape of the bearing housing 110.

The coupling section 141a includes a stopper 170, which can be in the form of a ring and positioned at an upper portion of the coupling section 141a to make contact with the upper surface of the rotating shaft 120. The stopper 170 makes contact with the rotating shaft 120 at a predetermined position, which is offset from the center of the upper surface of the rotating shaft 120. In addition, the upper surface of the rotating shaft 120 is partially exposed through the stopper 170. The stopper 170 can be integrally formed with the coupling section 141a.

Since the stopper 170 makes contact with the upper surface of the rotating shaft 120, the rotor yoke 141 can be inhibited from moving downward, even if load is applied to the rotor yoke 141 from the top thereof.

### Second Embodiment

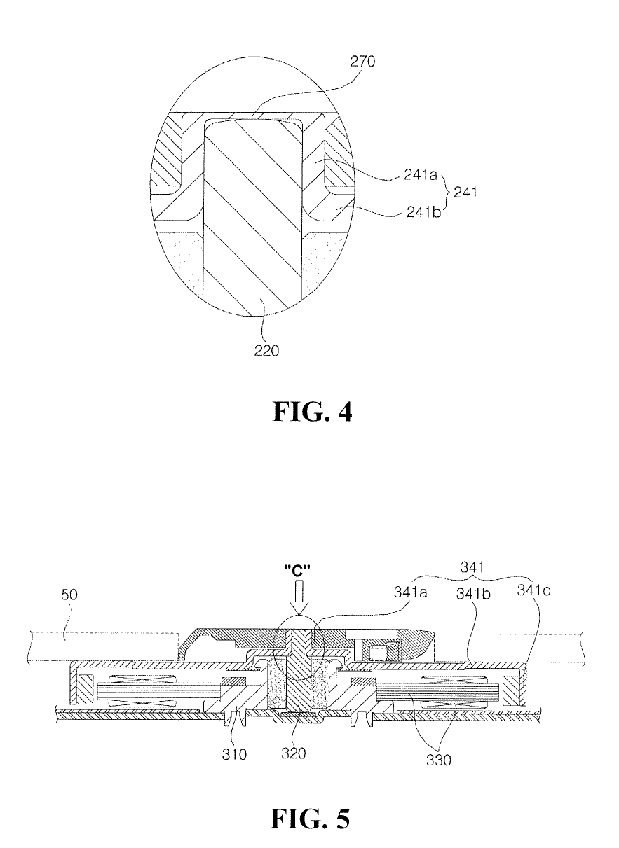

FIG. 3 is a sectional view showing the structure of a spindle motor according to an embodiment, and FIG. 4 is an enlarged view of “B” shown in FIG. 3.

The second embodiment will be described while focusing on the differences relative to the first embodiment.

Referring to FIGS. 3 and 4, a rotor yoke 241 can include a coupling section 241a, which is fitted and bonded around the outer peripheral surface of a rotating shaft 220 protruding upward from a bearing housing 210, a ring-shaped table 241b extending outward from a lower outer peripheral surface of the coupling section 241a to support a disk 50 mounted thereon, and an outer wall 241c extending downward from the outer peripheral surface of the table 241b to surround a stator 230.

A stopper 270 can be provided at an upper portion of the coupling section 241a covering the upper portion of the coupling section 241a. The stopper 270 can be integrally formed with the coupling section 241a.

The stopper 270 can make contact with the center of the upper surface of the rotating shaft 220. In addition, the stopper 270 can shield the upper surface of the rotating shaft 220.

Since the stopper 270 makes contact with the upper surface of the rotating shaft 220, the rotor yoke 241 can be inhibited from moving downward, even if load is applied to the rotor yoke 241 from the top thereof.

### Third Embodiment

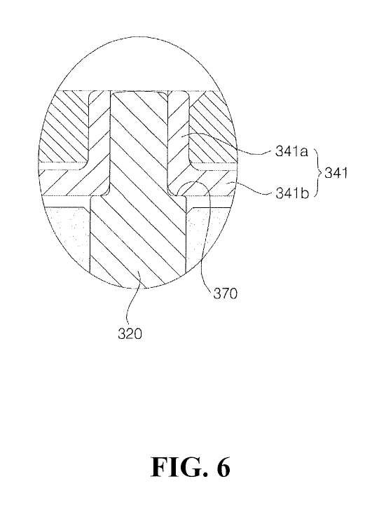

FIG. 5 is a sectional view showing the structure of a spindle motor according to an embodiment, and FIG. 6 is an enlarged view of “C” shown in FIG. 5.

The third embodiment will be described while focusing on the differences relative to the first embodiment.

Referring to FIGS. 5 and 6, in an embodiment, a device for preventing a rotor yoke 341 from moving toward the lower end portion of a rotating shaft 320 can be provided on the rotating shaft 320.

In detail, the rotor yoke 341 can include a coupling section 341a, which is fitted and bonded around the outer peripheral surface of the rotating shaft 320 protruding upward from a bearing housing 310, a ring-shaped table 341b extending outward from a lower outer peripheral 30 surface of the coupling section 341a to support a disk 50 mounted thereon, and an outer wall 341c extending downward from the outer peripheral surface of the table 341b to surround a stator 330.

The rotating shaft 320 can have first and second diameters, in which the first diameter is larger than the second diameter. An upper surface 370 of a lower portion of the rotating shaft 320 having the first diameter and a lateral surface of an upper portion of the rotating shaft 320 having the second diameter can make contact with the coupling section 341a of the rotor yoke 341.

The upper surface 370 of the lower portion of the rotating shaft 320 can inhibit the rotor yoke 341 from moving downward, even if load is applied to the rotor yoke 341 from the top thereof.

Although not shown in the drawings, similar to FIGS. 2 and 4, a stopper 170 or 270 that makes contact with the upper surface of the upper portion of the rotating shaft 320 can be provided in the coupling section 341a.

As described above, according to embodiments of the spindle motor, the coupling section of the rotor yoke, which is fitted and bonded around the rotating shaft, can be supported by making contact with a top surface of the rotating shaft, so that the rotor yoke can be inhibited from moving downward, even if load is applied to the rotor yoke from the top thereof. Accordingly, reliability of the product can be improved.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A spindle motor comprising:
a base;
a bearing housing supported on the base and having a bearing therein;
a rotating shaft rotatably supported by the bearing;
a stator installed around the bearing housing and having a core and a coil; and
a rotor coupled with the rotating shaft, the rotor comprising:
a rotor yoke supported on a top surface of the rotating shaft, and a magnet supported by the rotor yoke.

2. The spindle motor according to claim 1, wherein the stator is coupled with the bearing housing.

3. The spindle motor according to claim 1, wherein the rotor yoke comprises a coupling section coupled with the rotating shaft, a table extending outward from the coupling section to mount a disk thereon, an outer wall extending from the table to be coupled with the magnet, and a stopper provided in the coupling section to make contact with the top surface of the rotating shaft.

4. The spindle motor according to claim 3, wherein the stopper makes contact with the top surface of the rotating shaft at an edge region of the top surface of the rotating shaft.

5. The spindle motor according to claim 3, wherein the stopper makes contact with a center of the top surface of the rotating shaft.

6. The spindle motor according to claim 3, wherein the top surface of the rotating shaft is partially exposed through the stopper.

7. The spindle motor according to claim 3, wherein the stopper shields the top surface of the rotating shaft.

8. A spindle motor comprising:
a base having a bearing housing;
a bearing installed in the bearing housing;
a rotating shaft rotatably supported by the bearing, wherein the rotating shaft comprises a lower portion having a first diameter and an upper portion having a second diameter smaller than the first diameter;
a stator installed around the bearing housing and having a core and a coil; and
a rotor comprising:
a rotor yoke making contact with a top surface of the lower portion of the rotating shaft and a lateral surface of the upper portion of the rotating shaft, and
a magnet supported by the rotor yoke.

9. The spindle motor according to claim 8, wherein the stator is coupled with the bearing housing.

10. The spindle motor according to claim 8, wherein the rotor yoke comprises a coupling section coupled with the rotating shaft to make contact with the top surface of the lower portion of the rotating shaft and the lateral surface of the upper portion of the rotating shaft, a table extending outward from the coupling section to mount a disk thereon, and an outer wall extending from the table to be coupled with the magnet.

11. The spindle motor according to claim 10, further comprising a stopper provided in the coupling section to make contact with the top surface of the upper portion of the rotating shaft.

12. The spindle motor according to claim 11, wherein the stopper makes contact with the top surface of the upper portion of the rotating shaft at an edge region of the top surface of the upper portion of the rotating shaft.

13. The spindle motor according to claim 11, wherein the stopper makes contact with a center of the top surface of the upper portion of the rotating shaft.

14. The spindle motor according to claim 11, wherein the top surface of the upper portion of the rotating shaft is partially exposed through the stopper.

15. The spindle motor according to claim 11, wherein the stopper shields the top surface of the upper portion of the rotating shaft.
